(19) United States
(12) Patent Application Publication
(10) Pub. No.: US 2021/0154825 A1
(43) Pub. Date: May 27, 2021

(54) FLEXIBLE BOLT AND FASTENER ORGANIZER

(71) Applicant: Nathaniel Armstrong, Centerville, TN (US)

(72) Inventor: Nathaniel Armstrong, Centerville, TN (US)

(21) Appl. No.: 16/950,038

(22) Filed: Nov. 17, 2020

Related U.S. Application Data
(60) Provisional application No. 62/939,408, filed on Nov. 22, 2019.

(51) Int. Cl. B25H 3/06

(52) U.S. Cl. CPC B25H 3/06

(57) ABSTRACT

A flexible bolt and fastener organizer to hold a variety of fasteners such as, bolts, nuts, screws, rivets, dowels, drill bits, and other such fasteners in an orderly manner and specific orientation to facilitate easy access to the fasteners while repairing and restoring motor vehicles, motorbikes, trailers and other machines. The organizer is comprised of a plurality of holes extending from the front to the back of the main body which helps to effectively secure the fasteners inserted through the holes. The organizer is constructed from a flexible silicone with a Shore A 35 Hardness which allows the holes in the main body to stretch sufficiently to hold larger bolts, nuts and other fasteners and also makes the organizer flexible and light in weight to transport. The organizer can be hung from a pole on a nail or laid flat on a surface to hold the fasteners.

### CROSS REFERENCE TO RELATED APPLICATION

This application claims priority under 35 USC 119 (e) to U.S. Provisional Patent Application Ser. No. 62/939,408 filed Nov. 22, 2019 which is incorporated herein by reference, in its entirety.

### FIELD OF THE INVENTION

The present invention is generally related to holders for fasteners. More particularly, the invention is related to a flexible bolt and fastener organizer.

### BACKGROUND OF THE INVENTION

The repair and restoration of automobiles usually requires the disassembly of particular structural parts of the vehicle which are held together by a variety of fasteners such as bolts, screws, nuts etc., of various shapes and sizes. Each of these fasteners which may look outwardly the same are in fact specifically meant to be used to secure only the particular structural parts of the vehicle from which they were removed, for the safe operation of the vehicle after it is repaired. Accordingly, it is imperative that once the fasteners are removed from a particular structural part of a vehicle, that they be separately held in an easily accessible space for retrieval, and placed back in the exact spots from which they were removed from the vehicle, to retain the integrity of the restored vehicle. The same precautions and procedures apply to repairing other vehicles such as motorbikes, trailers and other machines.

A few prior art describe holders for fasteners such as the rolling tool cart of U.S. Pat. No. 7,845,501 to Fosburg et al., which comprises a mountable pegboard device to hold tools that can be mounted permanently, or removably to the side walls of a rolling tool cart. U.S. Pat. No. 7,150,362 to Questiaux et al., describes a holder for storing a plurality of fasteners having two side walls and an elongated bracket, a wire tie, or the like for holding differently shaped fasteners to the holder. U.S. Pat. No. 8,118,162 to McEwin et al., describes a fastener organizing system for storing nuts, bolts and other fasteners in a logical order during the disassembly and assembly of parts, vehicles, or machines. This prior art system comprises a planar substrate with apertures of various sizes and shapes for holding the fasteners which do not penetrate through into the back surface of the holder to facilitate holding the fasteners securely within the various apertures on the front surface of the holder.

The present invention is a flexible bolt and fastener organizer that can be distinguished from the fastener holders described in the prior art. The fastener holder of the present invention is a stand-alone, single, square-shaped flexible mat structure that does not require additional support structures to hold it up as required by the fastener holders in the prior art.

The features and advantages of the flexible bolt and fastener organizer of the present invention will become obvious to one skilled in the art through the summary of the invention, the drawings presented along with the detailed description of the invention, and the claims that follow.

### SUMMARY OF THE INVENTION

The present invention is a flexible, bolt and fastener organizer in the form of a flexible mat that is substantially square-shaped in structure with an approximate dimension of 25 cm×25 cm xl cm, having a plurality of holes extending from the front side to the back side of the mat structure to hold a variety of bolts, screws, rivets, dowels, drill bits, and other fasteners that are routinely used for the repair and restoration of automobiles and other machines. Other embodiments may have dimensions commiserate with the type and size of fasteners on products being repaired.

It is an object of the present invention to provide a flexible, lightweight, and portable bolt and fastener organizer that can be used in an automotive and/or other mechanics shop to organize bolts and other fasteners in an orderly manner and specific orientation to facilitate easy access to the fasteners once they are removed from parts of vehicles, or other machines during repair.

In the exemplary embodiment of the bolt and fastener organizer of the present invention, the mat-like, main body of the organizer is comprised of a plurality of holes that extend from the front to the back of the mat. Through these holes, various sizes of bolts, screws, rivets, dowels, drill bits and other fasteners can be inserted and held securely. The majority of these holes are 7 mm in diameter, allowing the insertion of small to medium fasteners. The holes close to the perimeter of the mat near the edges and around the provided writing pad area are smaller, allowing for the storage and organizing of fasteners or other objects under 7 mm in size. The mat also has a larger hole in the upper corner (either right or left side of the mat) for hanging up the mat on a nail or other holder positioned on a pole or other structure close to the area of repair work, for easy access to the bolts and fasteners.

In the exemplary embodiment of the bolt and fastener organizer of the present invention, the top area of the mat features a pad for writing instructions, or labeling items held on the mat. For example, if bolts for a water pump are organized on the mat, the top pad can be inscribed with the label “water pump.”

In the exemplary embodiment of the bolt and fastener organizer of the present invention, the mat is constructed of silicone with a Shore A 35 Hardness (Shore Hardness is a measure used to determine the resistance of a material to indentation). A material with a Shore A 35 Hardness such as the bolt and fastener organizer of the present invention is soft and flexible which allows the holes in the mat to stretch significantly up to roughly 16 mm in diameter, to hold bigger bolts and other fasteners. The mat is also heat resistant, oil resistant, and chemical resistant which is vital when used near vehicles.

In this summary of the invention, and in the specification in general, reference to, an “exemplary embodiment” means that a particular feature, structure, or characteristic described in conjunction with the referenced embodiment is included in at least some embodiments, but not necessarily all embodiments of the invention. The objects and features of the present invention of a flexible bolt and fastener organizer as described in this summary of the invention will be further appreciated and will become obvious to one skilled in the art when viewed in conjunction with the drawings, detailed description of the invention and the appended claims.

### BRIEF DESCRIPTION OF THE DRAWINGS

FIG. 1 is a perspective view of the flexible bolt and fastener organizer of the present invention.

FIG. 2 is another perspective view of the flexible bolt and fastener organizer of the present invention.

FIG. 3 is a side view of the flexible bolt and fastener organizer of the present invention.

FIG. 4 is a perspective view of the flexible bolt and fastener organizer of the present invention illustrating a plurality of nuts and bolts embedded within the holes of the flexible bolt and fastener organizer.

FIG. 5 is a perspective view of the flexible bolt and fastener organizer of the present invention hung on a nail attached to a pole.

### DETAILED DESCRIPTION OF THE INVENTION

The present invention is a compact and portable, flexible organizer for holding a variety of fasteners such as, bolts, nuts, screws, rivets, dowels, drill bits, and other such fasteners in an orderly manner and specific orientation to facilitate easy access to the fasteners while repairing and restoring motor vehicles, motorbikes, trailers, yard equipment and other machines. The flexible bolt and fastener organizer of the invention is also heat resistant, oil resistant, and chemical resistant.

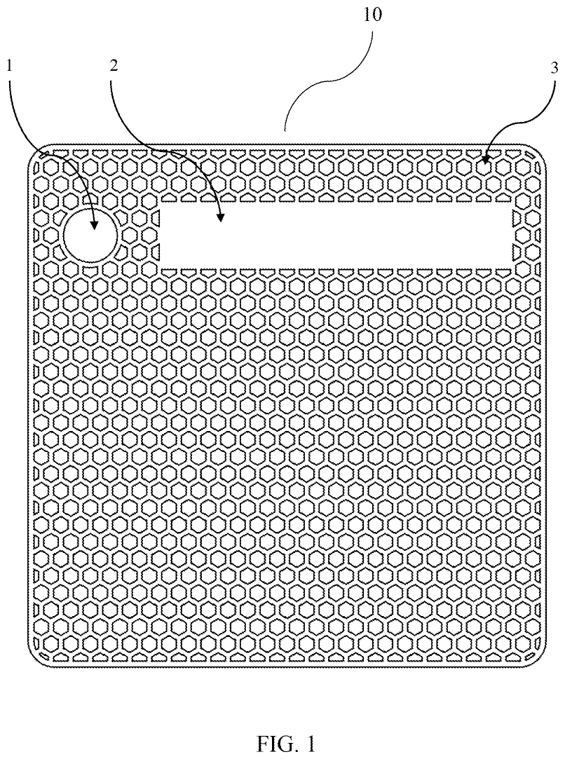

Referring now to the drawings wherein like numerals represent like components in the several views presented and discussed, and more particularly referring to FIG. 1 the figure is a perspective view of the flexible bolt and fastener organizer 10 of the present invention. The main body of the flexible, bolt and fastener organizer 10 is in the form of a mat that is substantially square-shaped in structure with an approximate dimension of 25 cm×25 cm×1 cm. The body of the mat is covered from end to end with a plurality of holes 3 of identical dimension. The holes 3 extend from the front side to the back side of the mat structure to enable a variety of nuts, bolts and other fasteners of different sizes to be inserted through these holes 3 and be securely held in place on the mat. The body of the mat is constructed of silicone with a Shore A 35 Hardness which allows the holes 3 in the mat to stretch significantly up to roughly 16 mm in diameter, to enable holding bigger bolts, nuts and other fasteners. The Shore A 35 Hardness also makes for a product that is light in weight and therefore easily transportable from location to location.

Referring again to FIG. 1 the flexible bolt and fastener organizer 10 is configured with a large hole 1 at the top end of one side of the main body (in this figure, the top left side of the main body) to facilitate hanging of the flexible bolt and fastener organizer 10 from a pole or other such structure. The top area of the organizer 10 features a pad 2 for writing instructions, or labeling items held on the mat. For example, if bolts or other fasteners for a water pump are organized on the mat, the top pad 2 can be inscribed with the label “water pump.”

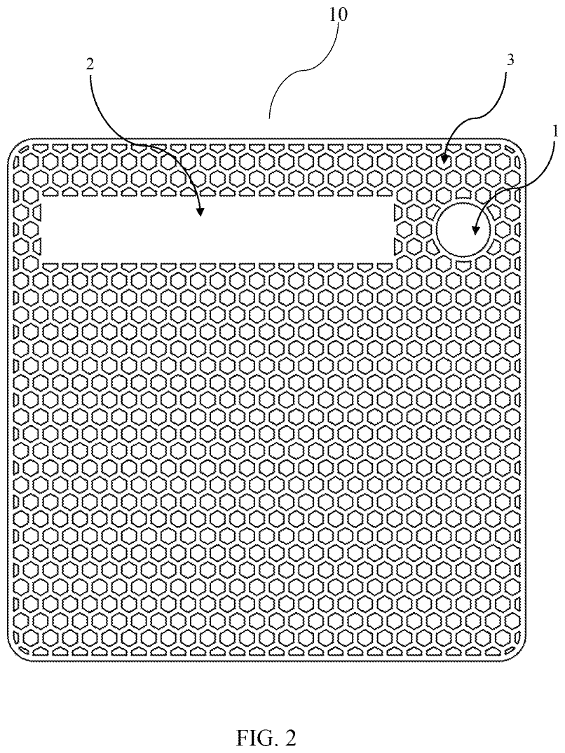

Referring now to FIG. 2 the figure is another perspective view of the flexible bolt and fastener organizer 10 of the present invention. In this figure, the large hole 1 is configured on the top right side of the main body and the writing pad 2 is to the left of the large hole 1. The majority of holes 3 in all embodiments of the flexible bolt and fastener organizer 10 are 7 mm in diameter, allowing the insertion of small to medium fasteners. The holes 3 close to the perimeter of the mat near the edges and around the writing pad 2 area are smaller, allowing for the storage and organizing of fasteners or other objects under 7 mm in size. Embodiments of the organizer 10 for use with products requiring electronic repair have holes 3 with a 1 mm diameter and embodiments of the organizer 10 for use with heavy machinery will have holes 3 of 15 mm or greater in diameter.

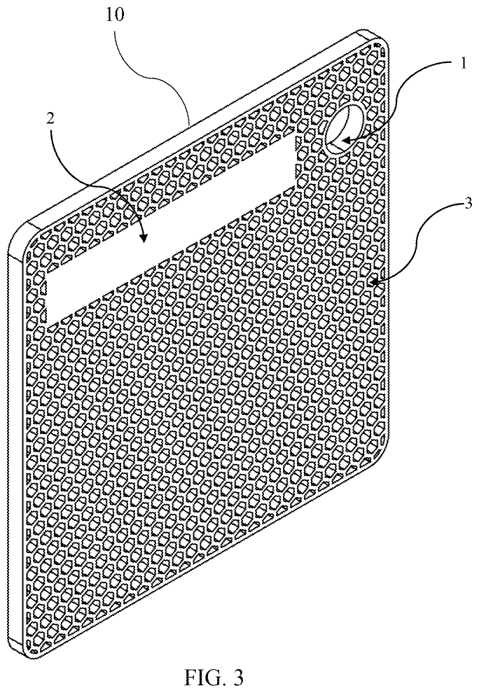

FIG. 3 is a side view of the flexible bolt and fastener organizer 10 of the present invention. In the exemplary embodiment of the organizer 10 the approximate dimensions of the main body is 25 cm×25 cm×1 cm. In other embodiments, these dimensions may be adjusted according to the needs of particular users. For example if the user requires the organizer to be hung from a nail on a pole to hold small bolts and other fasteners, the organizer 10 can be manufactured with smaller dimensions. If on the other hand, the user is seeking an organizer that can be laid on a flat surface, to hold larger and heavier bolts and fasteners, an organizer 10 with higher dimensions could be manufactured to suit that need.

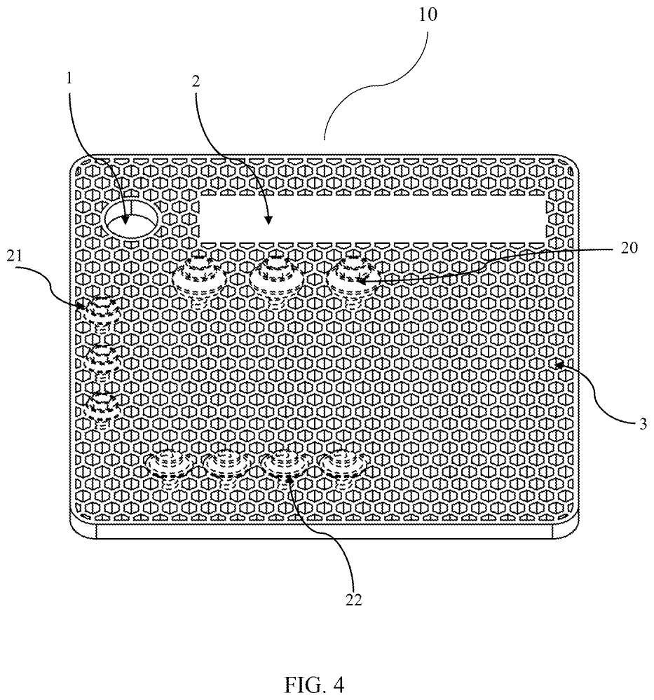

FIG. 4 is a perspective view of the flexible bolt and fastener organizer 10 of the present invention illustrating an example of a plurality of different sizes of bolts and other fasteners 20, 21 and 22 embedded within the holes 3 of the organizer 10 of the invention. In this view, the organizer 10 is placed on a flat surface and the plurality of bolts and other fasteners 20, 21 and 22 are placed into the holes 3 on different areas of the organizer 10. Although the dimensions of the holes 3 are uniform throughout the mat structure, the Shore A 35 Hardness of the silicone mat allows the holes 3 in the mat to stretch significantly up to roughly 16 mm in diameter, to hold bigger bolts, nuts and other fasteners.

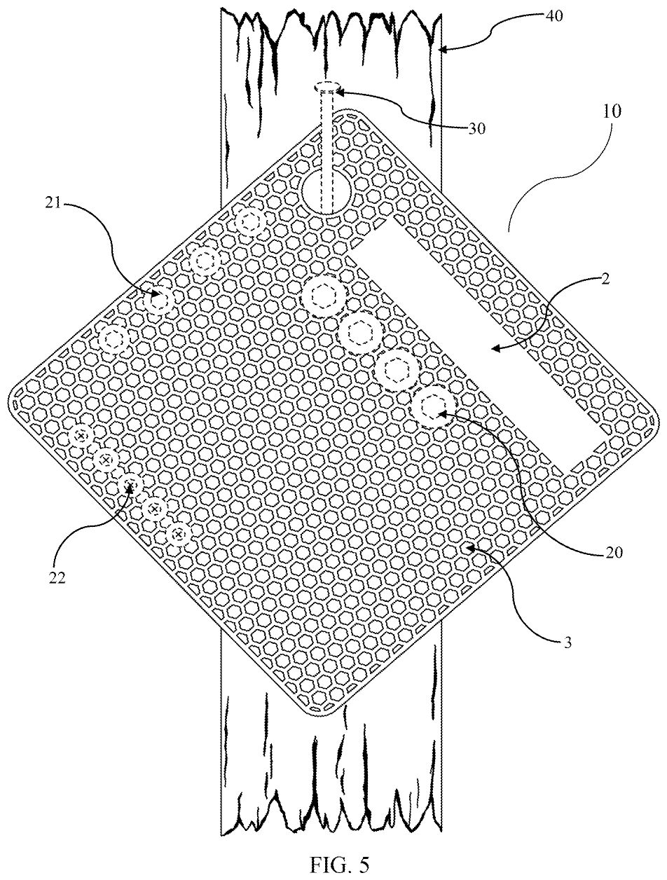

FIG. 5 is a perspective view of the flexible bolt and fastener organizer 10 of the present invention hung on a nail 30 attached to a pole 40 through the large hole 1. A Plurality of bolts and fasteners 20, 21 and 22 of different sizes are displayed on the main body of the organizer 10. The convenience of being able to hang the organizer 10 on a nail 30 on a pole 40 within easy reach of a user has beneficial practical applications for the flexible bolt and fastener organizer 10 of the present invention.

The foregoing detailed description of the flexible bolt and fastener organizer of the present invention through its figures and preferred embodiment should not be construed to limit the scope of the invention. It is to be understood that the embodiment of the invention as described herein do not limit any application or scope of the invention and that the invention can be carried out and practiced in various ways and implemented in embodiments other than the one outlined in the description above. It is to be further understood that the phraseology and terminology used to describe the invention are for descriptive purposes only. It should be understood and obvious to one skilled in the art that alternatives, modifications, and variations of the embodiment of the present invention may be construed as being within the spirit and scope of the appended claims.

1. A flexible bolt and fastener organizer comprising:
a substantially square-shaped main body;
said substantially square-shaped main body in the form of a mat;
said substantially square-shaped main body made of a silicone;
said substantially square-shaped main body comprised of a plurality of holes;
said plurality of holes extend from a front side of said main body to a back side of said main body of said flexible bolt and fastener organizer;
said main body having a large hole on a top end of said main body of said flexible bolt and fastener organizer; and
said main body having a labeling pad at a top end of said main body of said flexible bolt and fastener organizer.

2. The flexible bolt and fastener organizer of claim 1 wherein the approximate dimensions of the main body of the organizer is 25 cm×25 cm×1 cm.

3. The flexible bolt and fastener organizer of claim 1 wherein, the plurality of holes in the main body of the organizer are used to hold, bolts, nuts and other fasteners in an orderly manner and specific orientation to facilitate easy access to the fasteners while repairing and restoring motor vehicles, motorbikes, trailers, yard equipment and other machines.

4. The flexible bolt and fastener organizer of claim 1 wherein, the silicone used to construct the main body of the flexible bolt and fastener organizer has a Shore A 35 Hardness which allows the plurality of holes in the main body to stretch significantly up to roughly 16 mm in diameter, to enable holding bigger bolts, nuts and other fasteners.

5. The flexible bolt and fastener organizer of claim 1 wherein the large hole at the top end of the organizer is used to hang the organizer on a pole through a nail inserted through the large hole of the organizer.

6. The flexible bolt and fastener organizer of claim 1 wherein the organizer can be laid on a flat surface to hold, bolts, nuts and other fasteners on the organizer.
